(19) United States
(12) Patent Application Publication
(10) Pub. No.: US 2022/0056740 A1
(43) Pub. Date: Feb. 24, 2022

(54) ACTUATING APPARATUS FOR CONTROLLING A LOCKING SYSTEM OF A MOTOR VEHICLE AND METHOD FOR RELEASING A MANUALLY OPERATED EMERGENCY UNLOCKING DEVICE AND MOTOR VEHICLE

(71) Applicant: AUDI AG, Ingolstadt (DE)

(72) Inventors: Michael SOMMER, Ingolstadt (DE); Frank MAUERSBERGER, Ingolstadt (DE); Thomas POPP, Vohburg/Irsching (DE)

(73) Assignee: AUDI AG, Ingolstadt (DE)

(21) Appl. No.: 17/417,922

(22) PCT Filed: Jan. 9, 2020
(86) PCT No.: PCT/EP2020/050352

§ 371 Date: Jun. 24, 2021

(30) Foreign Application Priority Data
Jan. 30, 2019 (DE) 10 2019 201 209.4

(51) Int. Cl. E05B 81/90; E05B 77/02; E05B 79/20; E05B 83/36; E05B 81/24

(52) U.S. Cl. CPC E05B 81/90; E05B 77/02; E05B 81/25; E05B 83/36; E05B 79/20

(57) ABSTRACT

An actuating apparatus for controlling a locking system of a motor vehicle, including a circuit arrangement having a first input for receiving an operating signal and an output for providing a control signal to the locking system, the control signal being generated in dependence on the operating signal. The actuating apparatus further comprises a manually operated emergency unlocking device, and the circuit arrangement comprises a second input for receiving an event signal, wherein upon receipt of the event signal the manually operated emergency unlocking device is enabled for manual operation.

The invention relates to an actuating apparatus for controlling a locking system of a motor vehicle, comprising a circuit arrangement having a first input for receiving an operating signal and an output for providing a control signal to the locking system, wherein the circuit arrangement is designed to generate the control signal in dependence on the operating signal. Furthermore, the invention relates to a method for releasing a manually operated emergency unlocking device of an actuating apparatus for controlling a locking system of a motor vehicle as well as to a motor vehicle with an actuating apparatus.

From DE 10 2014 104 545 A1 a generic electronic module for a door handle of a vehicle according to the preamble is known. The electronics module comprises at least one conductor element on which at least one electrical component can be electrically arranged, wherein the conductor element and the connected electrical components form an electronics unit, and the electronics unit is connectable to at least one vehicle system, in particular a safety system, in terms of data technology.

From DE 10 2006 042 152 A1 a handle, which is in particular a door handle of a motor vehicle, for a keyless access and driving authorization control system is known.

From DE 10 2012 104 928 A1 a system for a security device of a motor vehicle with an immovable handle is known. When the handle is activated, an identification check can be carried out with a portable identification transmitter, wherein in the event of a positive identification, a lock can be actuated electrically, whereby a state of the lock can be changed.

A disadvantage of the known state of the art is that a vehicle locking system can no longer be controlled in the event of a fault in the vehicle electronics. Thus, it is not possible to open the locking system in the event of a malfunction of the vehicle electronics.

The invention is based on the task of reliably opening a locking system in the event of a fault in the vehicle electronics, including in the event of an accident.

The task is solved by the objects of the independent patent claims. Advantageous further embodiments of the invention are disclosed by the dependent patent claims, the following description and the figures.

The invention is based on the knowledge that in the event of a malfunction of the electronics, in particular in the event of an accident of the motor vehicle, the locking system of the motor vehicle can still be reliably opened by a manually operated emergency unlocking device.

An actuating apparatus for controlling a locking system of a motor vehicle is provided by the invention. The actuating apparatus comprises a circuit arrangement having a first input for receiving an operating signal and an output for providing a control signal to the locking system, wherein the circuit arrangement is designed to generate the control signal in dependence to the operating signal. In other words, the actuating apparatus may comprise a circuit arrangement receiving an operating signal via a first input and providing a control signal to the locking system via an output, wherein the control signal is generated in dependence on the operating signal. The circuit arrangement may comprise one or more electronic components, which may be connected by a printed circuit board. For example, an electronic component of the circuit arrangement may be adapted to receive an operating signal, which may be, for example, a radio signal and/or an electrical signal generated by a manual activation. For example, an actuation field may be touched by a user, whereby an operating signal may be generated. Additionally or alternatively, a radio signal can be received as an operating signal, by means of which an authentication can take place. Thereupon, depending on the operating signal, the control signal can be generated to control the locking system. Preferably, it can be checked whether the operating signal corresponds to a stored requirement, such as a stored encryption.

The circuit arrangement further comprises a second input for receiving an event signal, wherein the actuating apparatus comprises a manually operated emergency unlocking device, wherein the circuit arrangement is adapted to enable the manually operated emergency unlocking device for manual operation upon receipt of an event signal. In other words, upon receipt of an event signal via a second input, a manually operated emergency unlocking device can be enabled by the circuit arrangement. The manually operated emergency unlocking device may be a mechanical access to the locking system of the motor vehicle, which is only released when the event signal is received. The event signal can be generated, for example, when a fault is detected in a vehicle electronic system of the motor vehicle, which can occur, for example, when the motor vehicle is involved in an accident, or when it is detected that an on-board voltage of the motor vehicle falls below a predetermined voltage value.

The invention has the advantage that an actuating apparatus can be provided which, after receiving the operating signal, can electronically actuate the locking system to open and close it. Furthermore, in the event of an accident, the actuating apparatus can receive an event signal which can be generated, for example, by an impact sensor of the motor vehicle, in order to thereupon release the manually operated emergency unlocking device with which the locking system can be reliably opened. The invention thus makes it possible, on the one hand, to increase the convenience of opening and closing the locking system and, on the other hand, to provide a reliable emergency unlocking device that is independent of the vehicle electronics and by means of which safety can be increased.

The invention also includes embodiments by which additional advantages are obtained.

In one embodiment, the manually operated emergency unlocking device is designed to operate the locking system by a manual application of force by a user to unlock the vehicle. In other words, the locking system of the motor vehicle can be unlocked via muscle power of the user by means of the emergency unlocking device. For example, a switch, a lever or a cable or cable pull can be provided to manually access the locking system. This has the advantage that the locking system can be unlocked by manually applying force in the event of a fault in the vehicle electronics.

Preferably, the emergency unlocking device comprises at least one Bowden cable. This has the advantage that a force transmission by the user can be transmitted in a space-saving manner over a long distance, which can have a curved path. In addition, there is the advantage that the Bowden cable is protected by its sheathing from environmental influences such as rust.

In particular, the Bowden cable can include a handle element for transmitting a manual force. In the simplest case, a handle can be a loop at the end of the Bowden cable, but it is also possible to provide an annular pulling handle or holding handle with which the manual force can be applied. The advantage of this is that the improved grip on the Bowden cable allows a higher force to be applied.

In one embodiment, the actuating apparatus further comprises an actuator designed to make the emergency unlocking device accessible for the release of manual operation on an exterior of the motor vehicle. In other words, an actuator may be provided to release the emergency unlocking device to an exterior of the motor vehicle. The actuator may be actuated by the circuit arrangement upon receipt of the event signal to release the emergency unlocking device to the exterior of the motor vehicle. For example, the actuator may electrically or mechanically release an opening through which the emergency unlocking device is accessible or the emergency unlocking device may be ejected to an exterior of the vehicle by an action of the actuator. This embodiment has the advantage that the emergency unlocking device can be made accessible to the outside by means of the actuator.

Another embodiment provides that the actuator comprises a shape memory alloy wire designed to deform upon receiving the event signal and thereby release the emergency unlocking device. That is, the shape memory alloy wire can deform such that the emergency unlocking device is released. For example, the deformation of the wire can release a safety catch of a mechanism that ejects the emergency unlocking device. For example, a preloaded spring can be provided here that is retained by a locking cap. By deforming the shape memory alloy wire, a locking mechanism of the locking cap can be released and the locking cap can be ejected together with the emergency unlocking device by the spring. The shape memory alloy wire may deform upon receiving the event signal, for example, because a temperature change occurs in the wire when an electrical voltage is applied to the wire, which may trigger a phase transformation of the shape memory alloy. Materials for the shape memory alloy can be, for example, nickel-titanium alloys, that is, nitinol, or nickel-titanium-copper. However, other materials may include copper-zinc, copper-zinc-aluminum, copper-aluminum-nickel, iron-nickel-aluminum, iron-manganese-silicon, or zinc-gold-copper. This embodiment results in the advantage that the actuator can be provided in a space-saving manner and at the same time a high force can be provided compared to the volume of material.

Another embodiment provides that the circuit arrangement comprises a radio sensor and/or an actuation sensor, wherein the radio sensor and the actuation sensor are designed to receive the operating signal. In other words, the operating signal can be received by a radio sensor and/or an actuation sensor of the circuit arrangement. A radio sensor may be, for example, a near field communication (NFC) sensor, a proximity sensor of the vehicle in conjunction with automatic identification, in particular Kessy, and/or a remote control, in particular a remote control present in a motor vehicle key. The actuation field can, for example, be accessible from an exterior of the vehicle and comprise a button, a capacitive or inductive user interface, and/or a fingerprint sensor that can, for example, optically or capacitively detect a fingerprint of a user. This embodiment results in the advantage that a radio signal and/or an actuation signal can control the locking system and manual “turning of the key” is no longer necessary.

Another embodiment provides that the actuating apparatus further comprises a light element designed to illuminate the manually operated emergency unlocking device. The light element can be a lamp or luminaire, in particular a LED module. Preferably, the light element can also illuminate a vehicle door or a door handle. This embodiment has the advantage that the emergency unlocking device can be found even in the dark.

Another aspect of the invention relates to a method for releasing a manually operated emergency unlocking device of an actuating apparatus for controlling a locking system of a motor vehicle, wherein an operating signal is received via a first input and a control signal is provided via an output, wherein the control signal is generated as a function of the operating signal, A step of the method provides that upon receiving an event signal via a second input of the actuating apparatus, an enabling of the manually operated emergency unlocking device takes place. This offers the same advantages and variation possibilities as the actuating apparatus.

According to the invention, a motor vehicle with an actuating apparatus is also provided. The motor vehicle according to the invention is preferably designed as a motor vehicle, in particular as a passenger car or truck, or as a passenger bus. The actuating apparatus can have a processor device which is set up to carry out an embodiment of the method according to the invention.

For this purpose, the processor device may have at least one microprocessor and/or at least one microcontroller. Furthermore, the processor device can have program code which is set up to carry out the embodiment of the method according to the invention when executed by the processor device. The program code may be stored in a data memory of the processor device.

The invention also includes further embodiments of the method according to the invention which have features as already described in connection with the further embodiments of the actuating apparatus. For this reason, the corresponding further embodiments of the method according to the invention are not described again here.

The invention also includes combinations of the features of the described embodiments.

Examples of embodiments of the invention are described below. For this purpose shows:

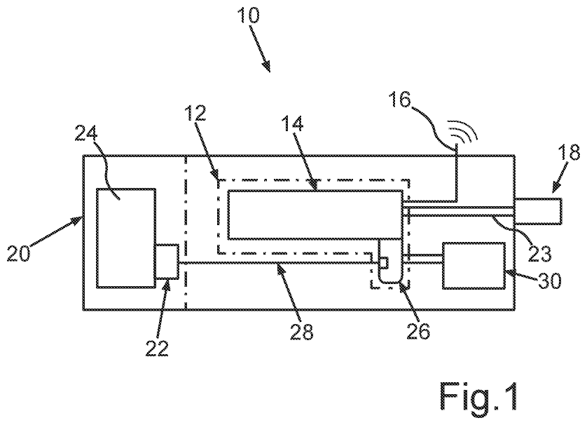

FIG. 1 a schematic representation of an actuating apparatus according to one embodiment;

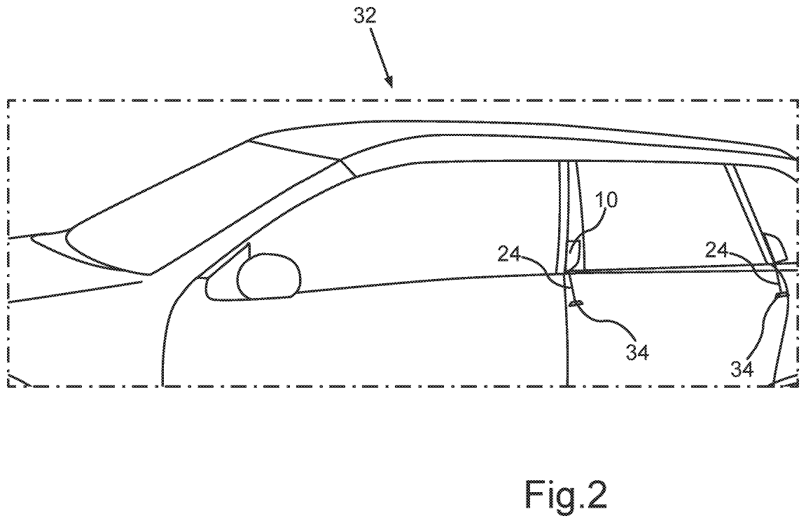

FIG. 2 a side view of a motor vehicle with an actuating apparatus according to one embodiment.

The examples of embodiments explained below are preferred embodiments of the invention. In the examples of embodiments, the described components of the embodiments each represent individual features of the invention that are to be considered independently of one another, each of which also independently further the invention. Therefore, the disclosure is intended to include combinations of the features of the embodiments other than those shown. Furthermore, the described embodiments may also be supplemented by further of the already described features of the invention.

In the figures, identical reference signs denote elements with identical functions.

In FIG. 1, an actuating apparatus 10 according to one embodiment is shown schematically. In this embodiment, the actuating apparatus 10 has a dry space 12 in which a circuit arrangement 14 is arranged. The dry space 12 may be configured to protect the circuit arrangement 14 from environmental influences, in particular from moisture. The circuit arrangement 14 may comprise a circuit board on which a radio sensor and/or an actuation sensor is arranged. In particular, the circuit arrangement 14 may comprise an NFC sensor, a proximity sensor, such as Kessy, and/or a remote control sensor. Furthermore, an actuation field may be provided which is accessible to an exterior of the vehicle and which may in particular be a pressure sensitive field, such as for example a capacitive or inductive surface.

In the case of the radio sensor, a first input for receiving an operating signal may be provided, which in this embodiment may be an antenna 16, in particular a near field communication (NFC) antenna. Furthermore, the circuit arrangement 14 may be coupled to a locking system of a motor vehicle (not shown) via an output 18, via which a control signal for controlling the locking system may be provided by the circuit arrangement 14 in response to the operating signal.

In the present embodiment, the actuating apparatus 10 further comprises an emergency unlocking device 20 that is accommodated in a wet space of the actuating apparatus 10, that is, that it may be accessible to an exterior of the vehicle. The emergency unlocking device 20 may comprise an ejection mechanism 22 that may release a cover for manual operation of the locking system upon receipt of an event signal, wherein the emergency unlocking device 20 may in particular comprise a Bowden cable 24.

The event signal, which may be received via a second input 23, may be generated, for example, when a predetermined condition occurs. The predetermined condition may be, for example, an accident signal from the vehicle, which for example may be output at the same time as activation of the airbag. Alternatively or additionally, the predetermined condition can also be a threshold value of the voltage of a vehicle network that is undershot. This can be used, for example, to ensure that the emergency unlocking device is released before there is no more on-board voltage. This means that the vehicle's locking system can be controlled manually even without on-board voltage or with low on-board voltage.

In particular, a preloaded spring may be provided as the ejection mechanism 22, which is released when the event signal is received, thereby ejecting the Bowden cable 24. To release the preloaded spring 22, an actuator 26 may be provided which may be controlled by the circuit arrangement 14. In particular, the actuator 26 may comprise a wire 28 made of a shape memory alloy, such as nitinol, which may be deformed by an electrical voltage applied to the wire 28. This deformation can then release the preloaded spring 22 thereby allowing the spring 22 to eject the Bowden cable 24. By means of the bowden cable 24, a user can then operate the locking system by a manual application of force to unlock the vehicle.

In addition to releasing the manually operated emergency unlocking device 20, a light element 30 may further be provided to illuminate the emergency unlocking device 20, in particular the Bowden cable 24. Preferably, the light element 30 may be a LED lamp that may be powered by its own battery. The light element 30 allows the emergency unlocking device 20 to be found even in the dark.

FIG. 2 shows a side view of a motor vehicle 32 with an actuating apparatus 10, wherein the actuating apparatus 10 in this example can be arranged in a recessed grip, which for example can be located on one of the vehicle pillars. Alternatively, the actuating apparatus 10 may also be arranged in a recessed grip or in a handle which may be located on a side surface of a vehicle door. However, the actuating apparatus 10 is not limited thereto, but can be arranged at any desired location of the motor vehicle 32, since the emergency unlocking device 20 can be arranged flexibly by means of the Bowden cable 24.

Further, the Bowden cable 24 may comprise a handle element 34 through which a manual force of a user may be better transmitted to the locking system of the motor vehicle 32. Particularly preferably, the handle element 34 may simultaneously be a closure cap of the emergency unlocking device 20, which is ejected upon release of the emergency unlocking device 20 via an ejection mechanism 22, which may for example be an ejection spring. In addition, it may be provided that the locking cap, or the handle element 34, is removable in the event that on-board voltage of the motor vehicle 32 is no longer present.

In another exemplary embodiment, a method for releasing a manually operated emergency unlocking device 20 for controlling a locking system of a motor vehicle 32 is provided. In the method, an operating signal is received via a first input and a control signal is provided via an output, wherein the control signal is generated in response to the operating signal. Upon receiving an event signal via a second input 23 of the actuation device 10, the manually operated emergency unlocking device 20 is enabled.

Overall, the example shows how the invention can provide an actuating apparatus 10 for an electronic external door actuation.

1-10. (canceled)

11. An apparatus for controlling a locking system of a motor vehicle, comprising a circuit arrangement having a first input for receiving an operating signal and an output for providing a control signal to the locking system, wherein the circuit arrangement is designed to generate the control signal in dependence on the operating signal, wherein the circuit arrangement has a second input for receiving an event signal,
wherein the actuating apparatus comprises a manually operated emergency unlocking device, wherein the circuit arrangement is designed to release the manually operated emergency unlocking device for manual operation upon receipt of the event signal.

12. The actuating apparatus according to claim 11, wherein the manually operated emergency unlocking device is designed to operate the locking system by a manual application of force by a user to unlock the motor vehicle.

13. The actuating apparatus according to claim 12, wherein the emergency unlocking device comprises at least one Bowden cable.

14. The actuating apparatus according to claim 13, wherein the Bowden cable includes a handle element for transmitting a manual force.

15. The actuating apparatus according to claim 11, wherein the actuating apparatus further comprises an actuator designed to make the emergency unlocking device accessible for the release of manual operation on an exterior of the motor vehicle.

16. The actuating apparatus according to claim 15, wherein the actuator comprises a shape memory alloy wire designed to deform upon receiving the event signal and thereby release the emergency unlocking device.

17. The actuating apparatus according to claim 11, wherein the circuit arrangement comprises a radio sensor and/or an actuation sensor, wherein the radio sensor and the actuation sensor are designed to receive the operating signal.

18. The actuating apparatus according to claim 11, wherein the actuating apparatus further comprises a light element designed to illuminate the manually operated emergency unlocking device.

19. A method for releasing a manually operated emergency unlocking device of an actuating apparatus for controlling a locking system of a motor vehicle, wherein an operating signal is received via a first input and a control signal is provided via an output, wherein the control signal is generated as a function of the operating signal,
wherein:
upon receiving an event signal via a second input of the actuating apparatus the manually operated emergency unlocking device is released.

20. A motor vehicle having an actuating apparatus according to claim 11.

21. The actuating apparatus according to claim 12, wherein the actuating apparatus comprises an actuator designed to make the emergency unlocking device accessible for the release of manual operation on an exterior of the motor vehicle.

22. The actuating apparatus according to claim 13, wherein the actuating apparatus further comprises an actuator designed to make the emergency unlocking device accessible for the release of manual operation on an exterior of the motor vehicle.

23. The actuating apparatus according to claim 14, wherein the actuating apparatus further comprises an actuator designed to make the emergency unlocking device accessible for the release of manual operation on an exterior of the motor vehicle.

24. The actuating apparatus according to claim 12, wherein the circuit arrangement comprises a radio sensor and/or an actuation sensor, wherein the radio sensor and the actuation sensor are designed to receive the operating signal.

25. The actuating apparatus according to claim 13, wherein the circuit arrangement comprises a radio sensor and/or an actuation sensor, wherein the radio sensor and the actuation sensor are designed to receive the operating signal.

26. The actuating apparatus according to claim 14, wherein the circuit arrangement comprises a radio sensor and/or an actuation sensor, wherein the radio sensor and the actuation sensor are designed to receive the operating signal.

27. The actuating apparatus according to claim 15, wherein the circuit arrangement comprises a radio sensor and/or an actuation sensor, wherein the radio sensor and the actuation sensor are designed to receive the operating signal.

28. The actuating apparatus according to claim 16, wherein the circuit arrangement comprises a radio sensor and/or an actuation sensor, wherein the radio sensor and the actuation sensor are designed to receive the operating signal.

29. The actuating apparatus according to claim 12, wherein the actuating apparatus further comprises a light element designed to illuminate the manually operated emergency unlocking device.

30. The actuating apparatus according to claim 13, wherein the actuating apparatus further comprises a light element designed to illuminate the manually operated emergency unlocking device.
